(19) United States
(12) Patent Application Publication
(10) Pub. No.: US 2002/0189076 A1
(43) Pub. Date: Dec. 19, 2002

(54) Stator winding method and apparatus

(76) Inventor: John M. Beakes, Fairborn, OH (US)

Correspondence Address: Dybvig & Dybvig, 22 Green Street, Dayton, OH, 45402, US

(21) Appl. No.: 10/120,894

(22) Filed: Apr. 11, 2002

Related U.S. Application Data
(60) Provisional application No. 60/285,799, filed on Apr. 23, 2001.

(51) Int. Cl. H02K 15/00; H02K 15/14; B23P 19/00

(52) U.S. Cl. 29/596; 29/606; 29/732

(57) ABSTRACT

A pair of winding forms for mounting on opposite sides of a pole piece of a stator core on which coils are to be wound are held on a stator core by a tongue and groove arrangement formed on the winding forms and by a releasable locking pin that retains the tongue in the groove. Stops surfaces on the winding forms engageable with the stator core prevent the winding form assembly from rotatably rocking during the winding of a coil onto the pole piece. Other surfaces on the winding forms are positioned to engage the stator core to prevent the winding forms from moving radially toward the center axis of the stator. A method is provided for assembling the winding forms on a stator core and removing the winding forms from the stator core using a standard winding form handling mechanism and air actuators for moving the locking pin.

### CROSS REFERENCE TO RELATED APPLICATION

This application claims the benefit of U.S. Provisional Application No. 60/285,799, filed Apr. 23, 2001.

### FIELD OF THE INVENTION

This invention relates to a method and apparatus for winding stators for dynamoelectric devices and, although not so limited, especially to a method and apparatus for winding two pole stators.

### INCORPORATION BY REFERENCE

The disclosures of U.S. Pat. No. 5,197,685, granted Mar. 30, 1993 to Alvin C. Banner, and U.S. Pat. No. 5,340,043, granted Aug. 23, 1994 to John M. Beakes and Lawrence E. Newman, are hereby incorporated by reference herein.

### BACKGROUND OF THE INVENTION

This invention is intended for use with well known methods and apparatus for winding stators wherein coils of wire drawn from sources of wire under tension are wound around the pole pieces on a laminated stator core by a reciprocating and oscillating winding shuttle or ram. The winding shuttle or ram is driven by a mechanism such as that shown in U.S. Pat. No. 4,158,314. A common practice when winding two pole stators in this fashion is to use two pairs of oppositely directed shrouds or winding forms, one pair for each pole, that guide the wire segments exiting from the winding head around the pole pieces. The shrouds or winding forms are usually secured to the stator by pairs of form-retaining clamps or blades but it has been recognized that there are disadvantages to the use of the form retaining blades. The manipulations required to operate the blades or clamps are time-consuming and significantly limit production speeds. In addition, space for insertion of the blades must necessarily be provided by a gap between the end faces of the stator core and the coil end turns, a factor which can have a negative effect upon the characteristics of the wound coils. For another thing, there have been reports that compounds used to trickle impregnate the stator coils occasionally flow through the gap into the bore of the stator.

The aforementioned Banner '685 patent discloses winding forms provided with mutually-engaging latching members which interconnect a pair of cooperating winding forms. A spring acting on one of the latch members serves to bias the winding forms into engagement with the stator assembly. The Banner '685 winding forms are designed for winding stators of the type having coil support extensions connected to the pole pieces and extending from both end faces of the stator for the purpose of supporting the stator coil end turns. The coil support extensions have outwardly directed coil-retaining fingers spaced from the end faces of the stator core. The winding forms are provided with pockets which receive the coil retaining fingers for preventing the winding forms from moving radially inwardly when stator coils are being wound.

The Beakes et al. '043 patent discloses improved winding form assemblies which, as in the Banner '685 assemblies, rely on pockets that receive coil-retaining fingers for preventing the winding forms from moving inwardly of the bore of the stator. The Beakes et al. '043 invention solved shortcomings of the Banner '685 construction, as is described in the Beakes et al. '043 patent.

### SUMMARY OF THE INVENTION

An object of this invention is to provide a method and apparatus for winding a two pole stator utilizing shrouds or winding forms which may be rapidly and securely assembled onto a stator core and rapidly disassembled from the stator core. A related object of this invention is to provide a method and an apparatus for winding stators using winding forms that do not require the use of form retaining blades. A further object of this invention is to provide a method and apparatus wherein the steps of assembly and disassembly of the winding forms on the stator cores can be accomplished automatically.

Yet another object of this invention is to provide an improved method and apparatus for clamping mutually-cooperating winding forms onto a stator core without the use of form retaining blades whereby the forms are reliably retained during high speed stator winding procedures.

In another aspect of this invention, an object is to reduce vibration associated with the use of winding forms which are not locked by form retaining blades.

In accordance with this invention, a winding form assembly including a pair of winding forms used to wind a stator coil around a pole piece is supported against radial inward movement by the pole piece. A tongue on one winding form engages in a groove on the other winding form of the same pair and a simple and reliable releasable locking pin connection retains the tongue in the groove and, accordingly, holds the two winding forms together. As in the case of the Beakes et al. '043 construction, a standard winding form handling mechanism, which has carriage-mounted support pins protruding into the winding forms, can be used to move the winding forms into position on the stator to be wound. As the winding forms are being moved into position, the tongue extending from one winding form enters the groove of its companion winding form. After the tongue is fully seated in the groove, a locking pin slidably mounted in the grooved winding form is moved into a transverse bore in the tongue so that the winding forms are securely connected together. Movement of the locking pin into the groove may be accomplished using an air actuator. After placement of the winding forms into proper position on the stator, the carriage support pins are removed from the winding forms and backed out of the way for subsequent winding operations. After winding, the support pins are again inserted into the winding forms, the locking pins removed from the transverse bore in the tongue, as by operation of an air actuator on the carriage, and the forms removed from the winding area. The next stator is then moved into the winding station.

Further in accordance with another aspect of this invention, the winding forms have surfaces positioned to engage the stator pole pieces to prevent the winding forms from moving radially toward the center axis of the stator.

In another aspect of this invention, the winding forms have stop members engaged with parts of the pole pieces to prevent the winding forms from rocking in a rotational direction during the winding of the coils. In one embodiment, stop surfaces are provided on the winding forms positioned close to or engaged with the radially innermost tips of the pole pieces so that a rotational rocking motion of the winding forms is practically eliminated. In another embodiment, a rotational rocking of the winding forms is prevented by pins on the winding forms received in apertures in the stator pole pieces.

Other objects and advantages will become apparent from the following description and the drawings.

### BRIEF DESCRIPTION OF THE DRAWINGS

FIG. 1 is an exploded perspective view of a stator to be wound and upper and lower pairs of male and female winding forms in accordance with one embodiment of this invention. In addition, FIG. 1 includes a fragmentary perspective view of portions of a carriage for supporting and positioning the female winding forms and locking pin positioning mechanisms for use with the winding forms.

FIG. 2 is an exploded perspective view of the lower female winding form and a fragment of the lower male winding form.

FIG. 3 is a fragmentary plan view with parts in cross section of the parts shown in FIG. 2 after the winding forms are fully engaged with one another. In FIG. 3 the male and female winding forms are nested together but not connected together.

FIG. 4 is a fragmentary cross-sectional view showing the parts illustrated in FIG. 3 after the male and female winding forms are connected together.

FIG. 5 is an elevational view showing both pairs of winding forms mounted on the stator.

FIG. 6 is a fragmentary end view of the stator as viewed in the direction of arrows 6-6 of FIG. 5 and showing, in cross section, parts of the female winding form for maintaining the position of the winding forms on the stator.

FIG. 7 is an exploded perspective view of a stator and a second embodiment of winding forms in accordance with this invention.

FIG. 8 is a simplified end elevational view of a stator in accordance with the second embodiment.

### DETAILED DESCRIPTION

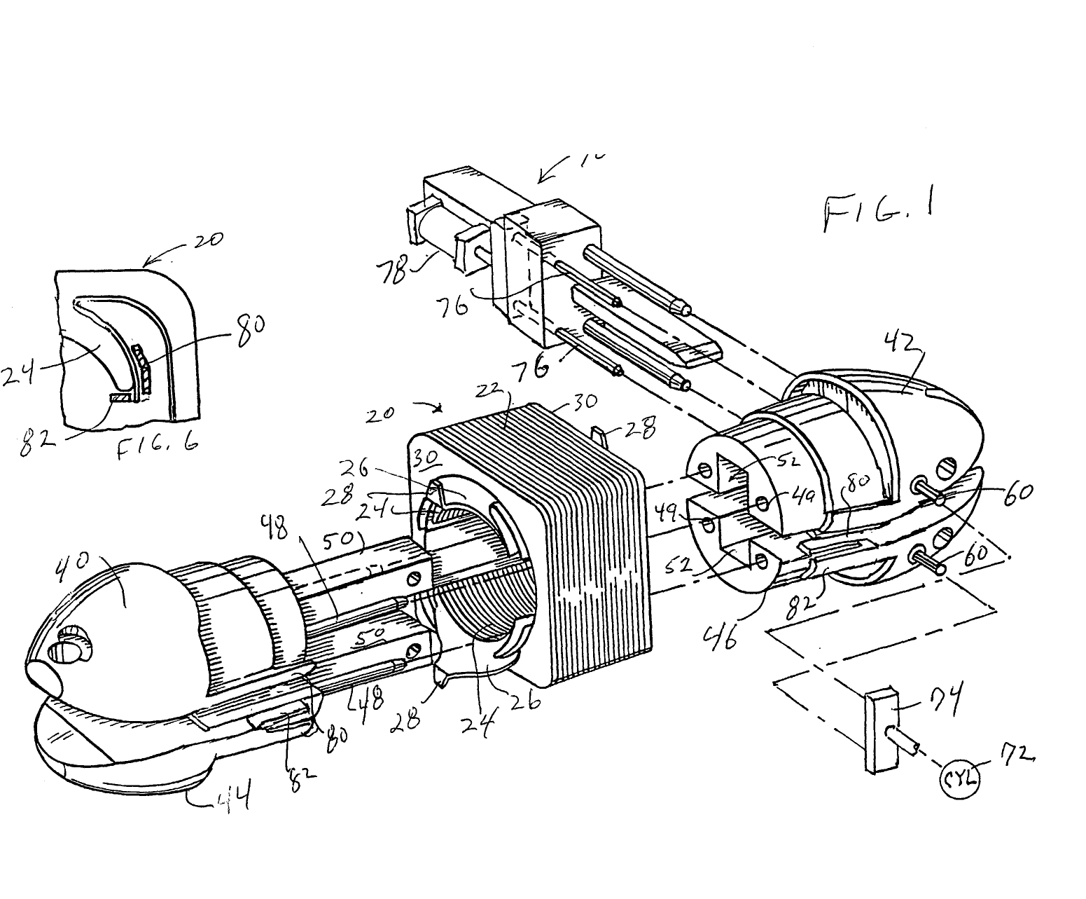

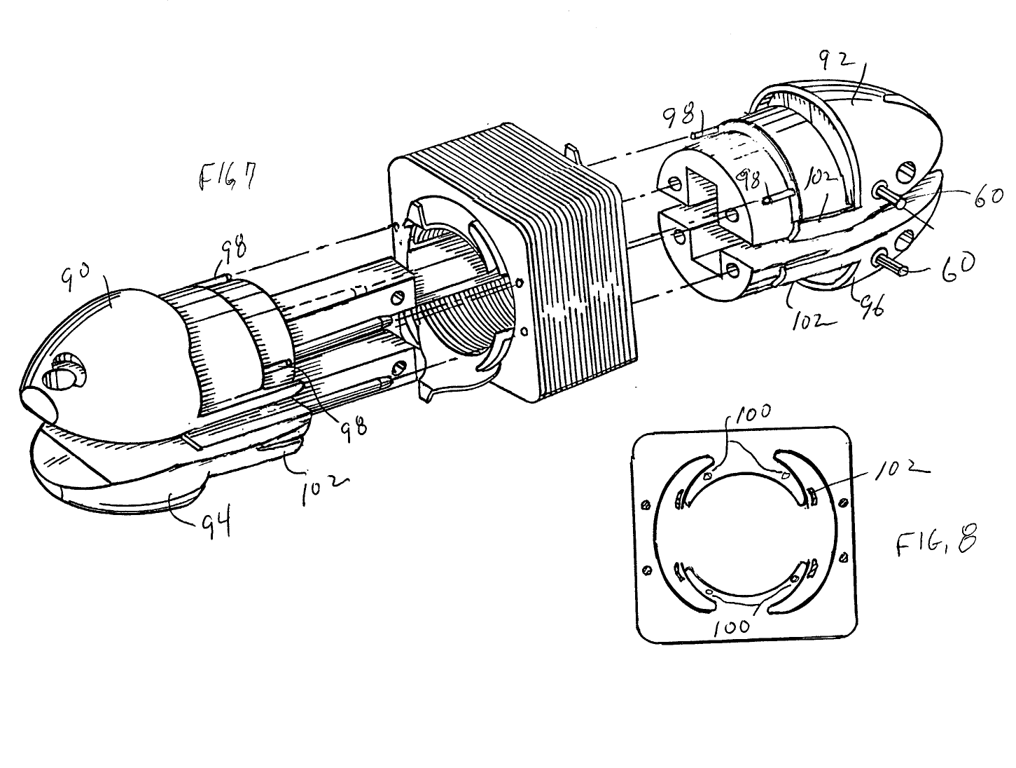

With reference to FIG. 1, this invention relates to a stator winding method and apparatus for winding a two pole stator, generally designated 20, for a dynamoelectric device. Stator 20 includes a substantially hollow, generally cylindrical laminated core 22 formed with a pair of longitudinally-extending, diametrically opposed, pole pieces 24. FIG. 6 shows a fragment of the upper pole piece 24. As is now a common practice, both ends of both pole pieces 24 are provided with longitudinally-extending coil support extensions 26 for supporting the end turns of the stator coils. Coil retaining fingers 28 project generally radially outwardly from the free ends of the coil support extensions 26, i.e. the ends most remote from the end faces of the stator core 22. Stator 20 additionally comprises plastic end plates 30 covering the end faces of the core 22. A s typical, the coil support extensions 26 may be integral with the end plates 30. As will become apparent, this invention is usable for winding stators which do not have coil support extensions and coil retaining fingers. As well known in the art, one or both end plates 30 may optionally be provided with terminal members (not shown).

Coils of wire (not shown) are wound on the pole pieces 24 by means of a winding shuttle or ram (not shown) that draws wires (not shown) from sources of wire under tension (not shown) and reciprocates through the bore of the stator 20 and oscillates at each end of each reciprocating stroke, as well known, to wind two coils simultaneously, one around each pole piece 24. The shuttle or ram may be driven by the mechanism shown in U.S. Pat. No. 4,158,314, or by anyone of several other mechanisms that have been developed for this purpose.

As is also well known, at the beginning of the winding operations, the free ends of the wires W are gripped by wire clamps (not shown) near the stator 20 and, after the coils are wound, the wire segments leading from the wound coils may be temporarily clamped by other clamps (not shown) in fixed relation to the stator 20.

There are four wire-guiding shrouds or winding forms shown in FIG. 1, namely a first, or male, and second, or female, upper winding forms 40 and 42, respectively, and a first, male and second, female lower winding forms 44 and 46, respectively. During assembly together, the male winding forms 40 and 44 are aligned with their respective female winding forms 42 and 46 by alignment pins 48 extending from the first, male forms 40 and 44 into aligned, cooperating sockets 49 in the second, female winding forms 42 and 46. The diameters of the sockets 49 are only slightly (on the order of 0.001 inch) greater than the alignment pins 48 so that there is a close fit between them. The winding forms are preferably made of hardened steel, as is conventional in the art.

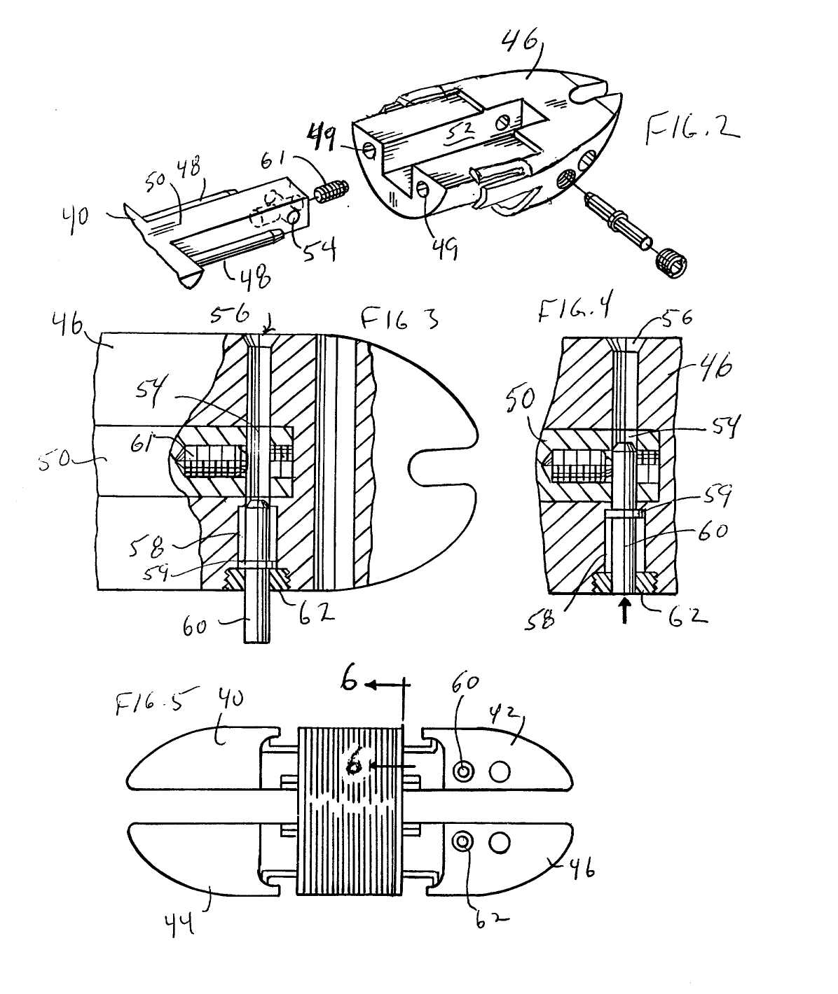

In accordance with this invention, a locking tongue 50 on each male winding form 40 and 44 is guided during assembly of the forms together into an elongate groove 52 in the corresponding female winding form 42 or 46. The locking tongues 50 have transverse bores 54 adapted to be aligned with a through bore 56 in its respective female winding form as evident from an inspection of FIGS. 3 and 4. Each through bore 56 has an enlarged diameter cavity 58 at one end in which an enlarged diameter mid-portion 59 of a locking pin 60 is trapped. The cavity 58 may comprise a counterbore partly closed at its outer end by a set screw 62 which has a central aperture that receives the outer end of the locking pin 60.

After the winding forms are assembled as shown in FIG. 3, the locking pins 60 are driven toward the opposite side of their associated female winding forms whereupon they are driven part way into the transverse bores 54 in the locking tongues 50, as shown in FIG. 4. Set screws 61 threaded in the free ends of the locking tongue 50 are used to resist retraction of the locking pins 60 from the transverse bores 54 in the locking tongues 50.

FIG. 1 illustrates parts of a carriage 70 used to engage and move the female winding forms 42 and 46 into and out of engagement with a stator at the winding station. After the winding forms are connected together, the locking pins 60 are driven into the transverse bore 54 by operation of an air actuator 72 that moves a pusher plate 74 into engagement with the exposed outer ends of the locking pins 60. After the winding of coils on the stator, the carriage 70 moves to engage and remove the female winding forms 42 and 46. At that time, a pair of pusher pins 76 mounted on the carriage 70 and moved by an air actuator 78 push the locking pins 60 out of the transverse bore 56. The pusher pins 76 are then retracted to enable the male and female winding forms to be separated from each other and moved away from the freshly-wound stator. The manner of moving the winding forms by the use of carriages may be identical to the way they are moved by carriages as known in the prior art as represented, for example, by the Beakes et al. '043 patent.

With reference to FIGS. 1 and 6, both the male and the female winding forms 40, 42, 44 and 46 are each provided with a first stop plate 80 that extends over portions of the pole pieces 24 to prevent the winding forms from moving radially inwardly toward the center of the stator core. Each of the winding forms 40, 42, 44 and 46 also has a second stop plate 82 that engages inwardly of the tips of the pole pieces 24 to prevent the winding forms from rotationally rocking on the stator core during the winding process.

With reference to FIGS. 7 and 8, a second embodiment of winding forms, designated 90, 92, 94 and 96 is illustrated. The latter winding forms may be identical to the winding forms 40, 42, 44 and 46 except that each of the winding forms 90, 92, 94 and 96, of the embodiment of FIG. 7 is provided with a pair of stop pins 98 adapted to enter apertures 100 in the opposite ends of the stator core to prevent the winding forms from moving radially inwardly or rotationally rocking relative to the stator core. In FIGS. 7 and 8 each of the winding forms is shown to include stop plates 102 for preventing inward movements of the winding forms. The latter plates 102 may be unnecessary in many if not all stator winding applications in those cases in which the winding forms are provided with stop pins 98.

Although the presently preferred embodiments of this invention have been described, it will be understood that within the purview of the invention various changes may be made within the scope of the following claims.

I claim:

1. For use in winding a two pole stator, a winding form assembly comprising:
a pair of winding forms for mounting on opposite sides of a pole piece of a stator core on which coils are to be wound;
a groove in one of said winding forms;
a tongue in the other of said winding forms engageable in said groove; and
a releasable locking pin that retains the tongue in the groove.

2. The winding form assembly of claim 1 further comprising stop members on said winding forms engaged with the stator core for preventing the winding form assembly from rotatably rocking during the winding of a coil onto the pole piece.

3. The winding form assembly of claim 1 further comprising surfaces on said winding forms positioned to engage the stator core to prevent the winding forms from moving radially toward the center axis of the stator.

4. A method of mounting the winding form assembly of claim 1 on a stator core comprising moving the winding forms into position on a stator to be wound by operation of a winding form handling mechanism, slidably mounting the locking pin in the grooved locking form and, after the tongue is seated in the groove, sliding a portion of said locking pin into a bore in said tongue.

5. The method of claim 4 wherein said locking pin is moved partly into said bore by operation of a first air actuator.

6. The method of claim 5 wherein said locking pin is moved completely out of said bore after the winding of a coil on a pole piece.

7. The method of claim 6 wherein said locking pin is moved completely out of said bore by operation of a second air actuator.

8. The method of claim 7 wherein said locking pin is moved generally toward said winding form handling mechanism by said first air actuator and generally away from said winding form handling mechanism by said second air actuator.

9. The method of claim 8 further comprising mounting said second air actuator on said winding form handling mechanism.
